(19) United States
(12) Patent Application Publication
(10) Pub. No.: US 2010/0115938 A1
(43) Pub. Date: May 13, 2010

(54) SPEED CONTROL DEVICE FOR HYDRAULIC ACTUATOR

(75) Inventor: Hiroshi Kobata, Kanagawa (JP)

Correspondence Address: RABIN & Berdo, PC, 1101 14TH STREET, NW, SUITE 500, WASHINGTON, DC, 20005, US

(73) Assignee: KAYABA INDUSTRY CO., LTD., Tokyo (JP)

(21) Appl. No.: 12/450,887

(22) PCT Filed: Apr. 16, 2008
(86) PCT No.: PCT/JP2008/057795

§ 371 Date: Oct. 16, 2009

(30) Foreign Application Priority Data
Apr. 18, 2007 (JP) 2007-109417

(51) Int. Cl. F16D 31/02

(52) U.S. Cl. 60/422; 60/459

(57) ABSTRACT

A working oil supply flow rate to hydraulic actuators (7-9) is controlled on the basis of target operating speeds (C7-C9). When a state in which one of the hydraulic actuators (7-9) has substantially stopped operating is detected, the target operating speed (C7-C9) of that hydraulic actuator is reset at a smaller value. A required flow rate Qb required of the hydraulic pump 22 is calculated using the reset target operating speed, whereupon the target operating speeds are corrected using a flow distribution factor Qr obtained by dividing a possible supply flow rate Qa by the required flow rate Qb. By controlling the working oil supply flow rate to the hydraulic actuators (7-9) on the basis of the corrected target operating speeds, when one of the hydraulic actuators (7-9) substantially stops operating, the supply of working oil to the other hydraulic actuators can be increased quickly.

### FIELD OF THE INVENTION

This invention relates to speed control of a hydraulic actuator when working oil discharged from a hydraulic pump is distributed to a plurality of hydraulic actuators.

### BACKGROUND OF THE INVENTION

A construction equipment such as a hydraulic shovel operates a plurality of hydraulic actuators for driving a boom, an arm, a bucket, and so on. These hydraulic actuators are operated at an operating speed corresponding to an operating amount of an operating lever by an operator. To achieve this, the operating speed of each hydraulic actuator must be calculated, and an amount of working oil supplied to each hydraulic actuator must be controlled in accordance with the calculated operating speed.

JPH09-095980A, published by the Japan Patent Office in 1997, proposes throttling the amount of working oil supplied to a hydraulic actuator in the vicinity of a stroke end to alleviate shock generated when the hydraulic actuator reaches the stroke end.

### SUMMARY OF THE INVENTION

When the plurality of hydraulic actuators are operated simultaneously at high speed in this type of construction equipment, a working oil supply ability of a hydraulic pump may reach a limit. As a result, the operating speeds of the boom, arm, bucket, and so on fall below expected speeds.

Under these conditions, when a certain hydraulic actuator reaches the stroke end or receives a large resistance to the stroke due to a load increase, a backlog occurs in the supply of working oil to the hydraulic actuator. However, in a conventional construction equipment in such a case, the working oil supply amount to the other hydraulic actuators is not immediately increased.

It is therefore an object of this invention to provide a speed control device for a hydraulic actuator with which, when one of a plurality of hydraulic actuators stops operating, a working oil supply amount to another hydraulic actuator can be increased instantaneously.

To achieve the object described above, this invention provides a speed control device for hydraulic actuators, which controls operating speeds of the hydraulic actuators operated by a working oil discharged from a hydraulic pump. The speed control device comprises control valves that control a supply flow rate of the working oil supplied to the respective hydraulic actuators in accordance with target operating speeds, a sensor that detects a state in which one of the hydraulic actuators has substantially stopped operating, and a programmable controller.

The controller is programmed to set the target operating speeds of the respective hydraulic actuators, reset the target operating speed of the hydraulic actuator that has substantially stopped operating to a smaller value, calculate a required flow rate to be supplied by the hydraulic pump on the basis of the reset target operating speed, calculate a flow distribution factor from a possible supply flow rate of the hydraulic pump and the required flow rate, and correct the target operating speeds of the respective hydraulic actuators in accordance with the flow distribution factor.

This invention also provides a speed control method for the hydraulic actuator described above. The method comprises setting the target operating speeds of the respective hydraulic actuators, controlling a supply flow rate of the working oil supplied to the respective hydraulic actuators in accordance with the target operating speeds, detecting a state in which one of the hydraulic actuators has substantially stopped operating, resetting the target operating speed of the hydraulic actuator that has substantially stopped operating to a smaller value, calculating a required flow rate to be supplied by the hydraulic pump on the basis of the reset target operating speed, calculating a flow distribution factor from a possible supply flow rate of the hydraulic pump and the required flow rate, and correcting the target operating speeds of the respective hydraulic actuators in accordance with the flow distribution factor.

The details as well as other features and advantages of this invention are set forth in the remainder of the specification and are shown in the accompanying drawings.

### BRIEF DESCRIPTION OF THE DRAWINGS

FIG. 1 is a hydraulic circuit diagram of a hydraulic shovel to which this invention is applied.

FIG. 2 is a hydraulic circuit diagram of a plurality of hydraulic actuators provided in the hydraulic shovel.

FIG. 3 is a flowchart illustrating an operating speed control routine executed on the hydraulic actuators by a controller according to this invention.

### DESCRIPTION OF THE PREFERRED EMBODIMENTS

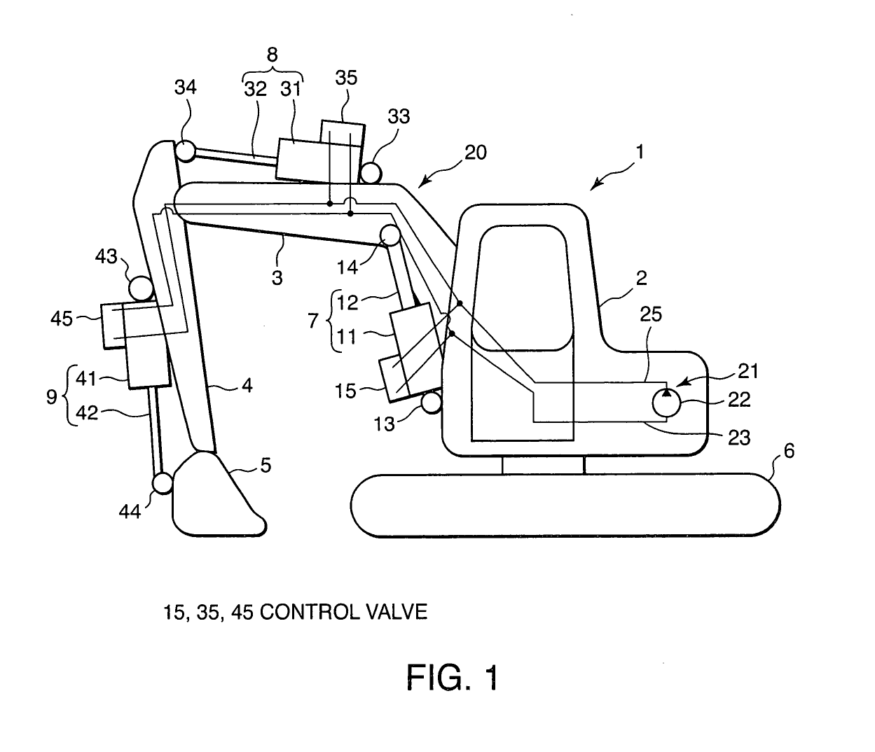

Referring to FIG. 1 of the drawings, a hydraulic shovel 1 includes a crawler type traveling mechanism 6, a vehicle body 2 provided on an upper portion of the traveling mechanism 6 to be capable of revolving, and an articulated front attachment 20 provided on the vehicle body 2.

The front attachment 20 includes a boom 3 connected to the vehicle body 2 so as to be free to rotate, a left/right pair of hydraulic actuators 7 for driving the boom 3, an arm 4 connected to a tip end of the boom 3 so as to be free to rotate, a single hydraulic actuator 8 for driving the arm 4, a bucket 5 connected to a tip end of the arm 4 so as to be free to rotate, and a single hydraulic actuator 9 for driving the bucket 5. The hydraulic actuators 7-9 are all constituted by linear actuators employing a hydraulic cylinder.

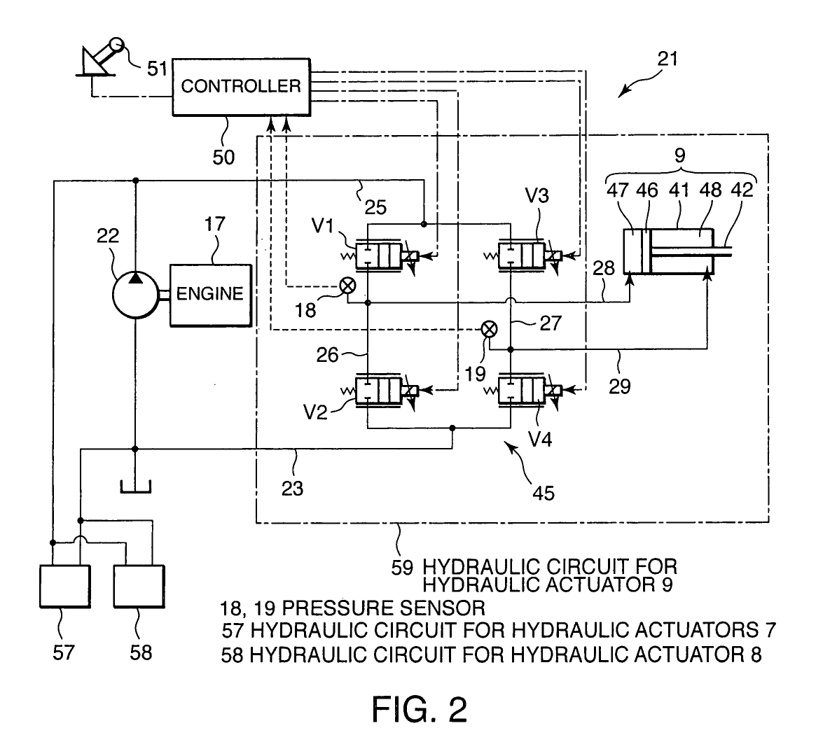

An oil pressure supply unit 21 is installed in the vehicle body 2. The oil pressure supply unit 21 includes a hydraulic pump 22 that is driven by an internal combustion engine 17 shown in FIG. 2. By causing the hydraulic actuators 7-9 to expand and contract in accordance with a supply of pressurized working oil from the oil pressure supply unit 21, the hydraulic shovel 1 rotates the boom 3, arm 4, and bucket 5 respectively to perform operations such as excavating the ground and moving earth. Instead of the bucket 5 for excavating the ground and moving earth, an attachment that performs another operation may be attached to the tip end of the arm 4.

The pair of hydraulic actuators 7 that drive the boom 3 are disposed so as to sandwich the boom 3 from the left and right. In each hydraulic actuator 7, oil pressure received by a piston accommodated in a cylinder tube 11 causes a piston rod 12 joined to the piston to expand and contract relative to the cylinder tube 11. A base end portion of each cylinder tube 11 is connected to the vehicle body 2 so as to be free to rotate via a shared support shaft 13, while a tip end portion of each piston rod 12 is connected to the boom 3 so as to be free to rotate via a shared support shaft 14. Working oil supply to the pair of hydraulic actuators 7 and working oil discharge from the pair of hydraulic actuators 7 are performed via a shared control valve 15. Thus, the pair of hydraulic actuators 7 are operated synchronously to rotate the boom 3 in a vertical direction.

The hydraulic actuator 8 that drives the arm 4 is installed in a back surface of the boom 3. In the hydraulic actuator 8, oil pressure received by a piston accommodated in a cylinder tube 31 causes a piston rod 32 joined to the piston to expand and contract relative to the cylinder tube 31. A base end portion of the cylinder tube 31 is connected to the boom 3 so as to be free to rotate via a support shaft 33, while a tip end portion of the piston rod 32 is connected to the arm 4 so as to be free to rotate via a support shaft 34. Working oil supply to the hydraulic actuator 8 and working oil discharge from the hydraulic actuator 8 are performed via a control valve 35. Thus, the hydraulic actuator 8 expands and contracts to rotate the arm 4 in a vertical direction.

The hydraulic actuator 9 that drives the bucket 5 is installed in a back surface of the arm 4. In the hydraulic actuator 9, oil pressure received by a piston accommodated in a cylinder tube 41 causes a piston rod 42 joined to the piston to expand and contract relative to the cylinder tube 41. A base end portion of the cylinder tube 41 is connected to the arm 4 so as to be free to rotate via a support shaft 43, while a tip end portion of the piston rod 42 is connected to the bucket 5 so as to be free to rotate via a support shaft 44. Working oil supply to the hydraulic actuator 9 and working oil discharge from the hydraulic actuator 9 are performed via a control valve 45. Thus, the hydraulic actuator 9 expands and contracts to rotate the bucket 5 in a vertical direction.

Referring to FIG. 2, the constitution of the oil pressure supply unit 21 that drives the hydraulic actuators 7-9 will be described.

As shown in FIG. 2, the oil pressure supply unit 21 includes the hydraulic pump 22 driven by the internal combustion engine 17. A drive circuit 57 for the pair of hydraulic actuators 7, a drive circuit 58 for the hydraulic actuator 8, and a drive circuit 59 for the hydraulic actuator 9 are connected to the hydraulic pump 22 in series.

The drive circuits 57-59 are constituted identically, and therefore the drive circuit 59 for the hydraulic actuator 9 will be described as an example.

A piston 46 is accommodated in the cylinder tube 41 of the hydraulic actuator 9 for the bucket 5. The piston rod 42 joined to the piston 46 projects from the cylinder tube 41 in an axial direction. A rod side oil chamber 48 and an anti-rod side oil chamber 47 are defined inside the cylinder tube 41 by the piston 46. Pressurized working oil is supplied selectively to the anti-rod side oil chamber 47 and the rod side oil chamber 48 from the hydraulic pump 22 via the control valve 45. Working oil discharge from the anti-rod side oil chamber 47 and the rod side oil chamber 48 is also performed via the control valve 45. The hydraulic actuator 9 is caused to expand and contract by the pressurized working oil supplied to one of the anti-rod side oil chamber 47 and the rod side oil chamber 48 via the control valve 45, and as a result, the bucket 5 is rotated thereby.

The control valve 45 is constituted by four solenoid valves V1-V4 forming a bridge circuit.

A high pressure passage 25 is connected to a discharge port of the hydraulic pump 22. The supply passage 25 bifurcates into branch passages 26 and 27 in the control valve 45.

A meter-in solenoid valve V1 that controls the flow of working oil supplied to the anti-rod side oil chamber 47 of the hydraulic actuator 9 and a meter-out solenoid valve V2 that controls the flow of working oil discharged from the anti-rod side oil chamber 47 of the hydraulic actuator 9 are provided in series in the branch passage 26. A meter-in solenoid valve V3 that controls the flow of working oil supplied to the rod side oil chamber 48 and a meter-out solenoid valve V4 that controls the flow of working oil discharged from the rod side oil chamber 48 are provided in series in the branch passage 27. The branch passage 26 passing through the solenoid valves V1 and V2 and the branch passage 27 passing through the solenoid valves V3 and V4 are connected to a low pressure passage 23 that extends to a suction port of the hydraulic pump 22.

A first passage 28 is connected to the branch passage 26 between the meter-in solenoid valve V1 and the meter-out solenoid valve V2. The first passage 28 is connected to the anti-rod side oil chamber 47 of the hydraulic actuator 9. A second passage 29 is connected to the branch passage 27 between the meter-in solenoid valve V3 and the meter-out solenoid valve V4. The second passage 29 is connected to the rod side oil chamber 48 of the hydraulic actuator 9.

The meter-in solenoid valve V1, meter-out solenoid valve V2, meter-in solenoid valve V3 and meter-out solenoid valve V4 are all constituted by solenoid flow control valves. Each solenoid valve V1-V4 is operated individually by a current signal output from a controller 50. An opening area of the valve is adjusted in accordance with the current, whereby the flow of the working oil passing through each solenoid valve V1-V4 is controlled to a value corresponding to the current signal.

Detected pressures from a pressure sensor 18 that detects a pressure of the first passage 28 and a pressure sensor 19 that detects a pressure of the second passage 29 are respectively input into the controller 50 as signals.

The controller 50 is constituted by a microcomputer including a central processing unit (CPU), a read-only memory (ROM), a random access memory (RAM), and an input/output interface (I/O interface). The controller may be constituted by a plurality of microcomputers.

The control valve 15 and the control valve 35 shown in FIG. 1 are constituted similarly to the control valve 45. The control valves 15, 35, 45 are disposed discretely in the vicinity of the respective hydraulic actuators 7, 8, 9.

By operating the control valves 15, 35, 45, the controller 50 switches the direction in which the working oil is supplied to the hydraulic actuators 7, 8, 9 and controls the supply flow of the working oil. The controller 50 thus drives the articulated front attachment 20 constituted by the boom 3, arm 4, and bucket 5 in order to use the bucket 5 connected to the tip end of the arm 4 to excavate the ground and move earth.

The controller 50 calculates target operating speeds C7, C8, C9 relating to operations of the respective hydraulic actuators 7, 8, 9 in accordance with an operating amount of an operating lever 51 by an operator. The controller 50 then adjusts respective openings of the control valves 15, 35, 45 in accordance with the target operating speeds C7, C8, C9. As a result of this operation, expansion/contraction speeds of the respective hydraulic actuators 7, 8, 9 are caused to correspond to the operating amount of the operating lever 51.

When the boom 3, the arm 4, and the bucket 5 are operated simultaneously at high speed, the flow of the working oil discharged from the hydraulic pump 22 may become insufficient.

In response to this problem, the controller 50 calculates a possible supply flow rate Qa relating to the hydraulic circuits 57, 58, 59 of the oil pressure supply unit 21 on the basis of a horse power of the internal combustion engine 17 that drives the hydraulic pump 22 and load information relating to the respective hydraulic actuators 7, 8, 9. The controller 50 also calculates a required supply flow rate Qb relating to the respective hydraulic actuators 7, 8, 9 on the basis of the respective target operating speeds C7, C8, C9 of the hydraulic actuators 7, 8, 9.

The controller 50 then determines a flow distribution factor Qr by dividing the possible supply flow rate Qa by the required supply flow rate Qb. The respective target operating speeds C7, C8, C9 of the respective hydraulic actuators 7, 8, 9 are then corrected by multiplying the flow distribution factor Qr by the target operating speeds C7, C8, C9. Through this correction processing, when the possible supply flow rate Qa of the oil pressure supply unit 21 is smaller than the flow rate Qb required to operate the front attachment 20, the operating speeds of the operative hydraulic actuators 7, 8, 9 are uniformly reduced. As a result, a situation in which the operating speed of one specific hydraulic actuator decreases dramatically, greatly impairing the operability of the front attachment 20, is prevented.

When one of the hydraulic actuators 7-9 substantially stops operating due to a load increase or one of the hydraulic actuators 7-9 substantially stops operating after reaching a stroke end, a deficiency in the supply flow rate of the oil pressure supply unit 21 is eliminated by halting the supply of working oil to the hydraulic actuator that has substantially stopped operating.

In this case, when the controller 50 continues to output a command relating to the correction processing described above, the flow rate of the working oil supplied to the operative hydraulic actuator falls below the capacity of the oil pressure supply unit 21, and as a result, the operating speeds of the operative hydraulic actuators remain low.

The controller 50 according to this invention detects a state in which one of the respective hydraulic actuators 7, 8, 9 has substantially stopped operating, and corrects the target operating speed output to the drive circuit of the hydraulic actuator that has substantially stopped operating in a speed reduction direction. Here, the term “substantially stopped operating” indicates a state in which the operating speed of the hydraulic actuator 7, 8, 9 is zero or a very low speed at or below a predetermined speed set close to zero.

For example, when the hydraulic actuator 7 substantially stops operating, the controller 50 corrects the target operating speed C7 output to the drive circuit 57 of the hydraulic actuator 7 in the speed reduction direction. A target operating speed C7L relating to the hydraulic actuator 7 that has substantially stopped operating is preferably set at a very small value larger than 0.

After setting the corrected target operating speed C7L at this value, the controller 50 calculates the required flow rate Qb on the basis of the target operating speeds C7L, C8, C9, and therefore the calculated required flow rate Qb takes a smaller value than the value obtained when the required flow rate Qb is calculated on the basis of the previous target operating speeds C7, C8, C9. As a result, the flow distribution factor Qr determined by dividing the possible supply flow rate Qa by the required flow rate Qb increases, leading to an increase in the supply flow rate of the working oil supplied to the drive circuits 58 and 59 of the operative hydraulic actuators 8 and 9. In other words, when the boom 3, arm 4, and bucket 5 are operated simultaneously and the boom 3 substantially stops operating, the operating speeds of the arm 4 and the bucket 5 are increased immediately. In so doing, the overall operating speed of the front attachment 20 can be increased.

Likewise, when the hydraulic actuator 8 or 9 substantially stops operating, the controller 50 increases the operating speeds of the operative actuators by correcting the target operating speed C8 or C9 in the speed reduction direction.

The controller 50 detects the state in which the hydraulic actuator 7 has substantially stopped operating in the following manner. On the basis of input signals from the pressure sensors 18 and 19, the controller 50 determines that a heavy load state in which a working oil pressure supplied to the hydraulic actuator 7, or in other words a load pressure, has risen beyond a predetermined pressure corresponds to a state in which the hydraulic actuator 7 has substantially stopped operating.

In FIG. 2, the drive circuits 57-59 have equivalent constitutions. Hence, the controller 50 determines a state in which the hydraulic actuator 8 or 9 has substantially stopped operating in a similar manner, i.e. on the basis of the input signals from the pressure sensors 18 and 19 provided in the respective drive circuits 58 and 59.

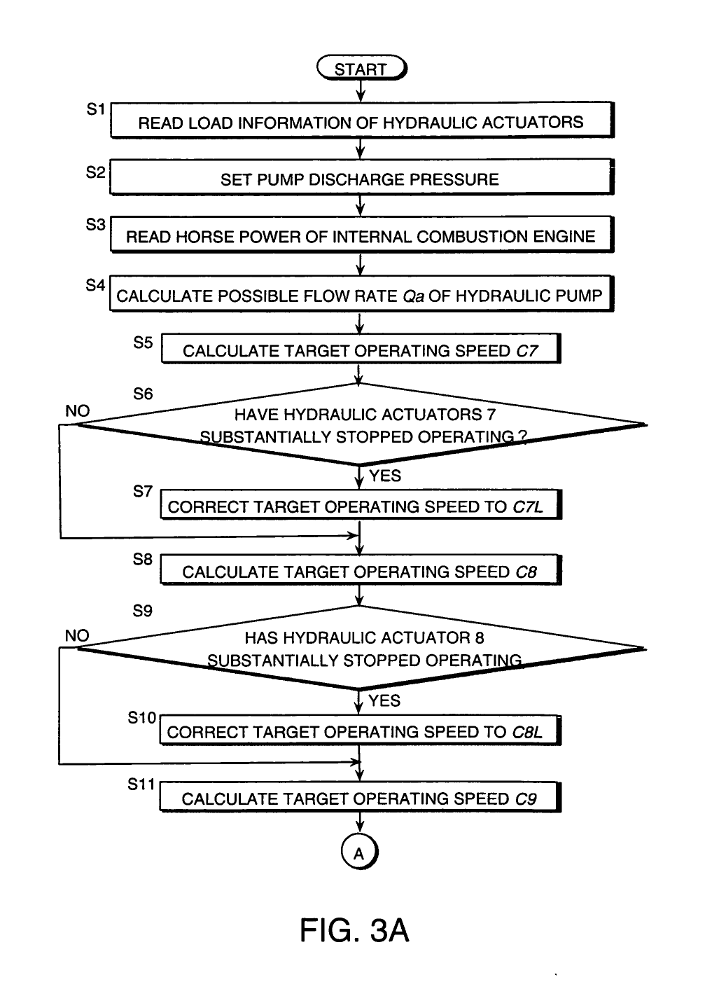

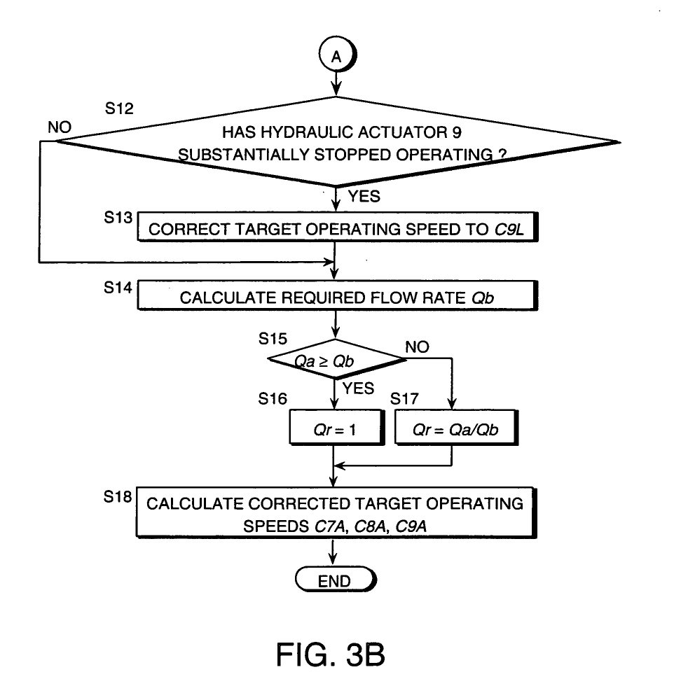

Referring to FIG. 3, an oil pressure control routine executed by the controller 50 to achieve the above control will now be described. The controller 50 executes this routine at fixed intervals, for example every ten milliseconds, while the front attachment 20 is working.

First, in a step S1, the controller 50 reads the load information relating to the hydraulic actuators 7, 8, 9 detected by the pressure sensors 18 and 19 of the drive circuits 57-59.

In a step S2, the controller 50 sets a discharge pressure of the hydraulic pump 22 from the load information by referring to a map stored in the ROM in advance.

In a step S3, the controller 50 reads the horse power of the internal combustion engine 17 that drives the hydraulic pump 22.

In a step S4, the controller 50 calculates the possible supply flow rate Qa of the hydraulic pump 22 on the basis of the discharge pressure of the hydraulic pump 22 and the horse power of the internal combustion engine 17.

In a step S5, the controller 50 calculates the target operating speed C7 of the hydraulic actuators 7 for the boom 3 in accordance with the operating amount of the operating lever 51 by the operator. By varying the opening of the control valve 15 in accordance with the target operating speed C7, the operating speed of the boom 3 required by the operator is obtained.

In a step S6, the controller 50 determines whether or not a state in which the hydraulic actuators 7 have substantially stopped operating has been established. When it is determined that a state in which the hydraulic actuators 7 have substantially stopped operating has been established, the controller 50 corrects the target operating speed C7 to the smaller value C7L in a step S7. When it is determined in the step S6 that a state in which the hydraulic actuator 7 has substantially stopped operating has not been established, the controller 50 does not correct the target operating speed C7 of the hydraulic actuator 7.

In a step S8, the controller 50 calculates the target operating speed C8 of the hydraulic actuator 8 for the arm 4 in accordance with the operating amount of the operating lever 51 by the operator. By varying the opening of the control valve 35 in accordance with the target operating speed C8, the operating speed of the arm 4 required by the operator is obtained.

In a step S9, the controller 50 determines whether or not a state in which the hydraulic actuator 8 has substantially stopped operating has been established. When it is determined that a state in which the hydraulic actuator 8 has substantially stopped operating has been established, the controller 50 corrects the target operating speed C8 to a smaller value C8L in a step S10. When it is determined in the step S9 that a state in which the hydraulic actuator 8 has substantially stopped operating has not been established, the controller 50 does not correct the target operating speed C8 of the hydraulic actuator 8.

In a step S11, the controller 50 calculates the target operating speed C9 of the hydraulic actuator 9 for the bucket 5 in accordance with the operating amount of the operating lever 51 by the operator. By varying the opening of the control valve 45 in accordance with the target operating speed C9, the operating speed of the bucket 5 required by the operator is obtained.

In a step S12, the controller 50 determines whether or not a state in which the hydraulic actuator 9 has substantially stopped operating has been established. When it is determined that a state in which the hydraulic actuator 9 has substantially stopped operating has been established, the controller 50 corrects the target operating speed C9 to a smaller value C9L in a step S13. When it is determined in the step S12 that a state in which the hydraulic actuator 9 has substantially stopped operating has not been established, the controller 50 does not reset the target operating speed C9 of the hydraulic actuator 9.

After calculating the target operating speeds C7 (C7L), C8 (C8L), C9 (C9L) of the hydraulic actuators 7, 8, 9 in this manner, the controller 50 calculates the required flow rate Qb on the basis of the target operating speeds C7 (C7L), C8 (C8L), C9 (C9L) in a step S14.

In a step S15, the controller 50 determines whether or not the possible supply flow rate Qa is equal to or greater than the required flow rate Qb. When the possible supply flow rate Qa is equal to or greater than the required flow rate Qb, all of the hydraulic actuators 7-9 can be operated at the speeds desired by the operator. When the possible supply flow rate Qa is smaller than the required flow rate Qb, the supply flow rate is insufficient, and therefore all of the hydraulic actuators 7-9 cannot be operated at the speeds desired by the operator.

When the possible supply flow rate Qa is equal to or greater than the required flow rate Qb, the controller 50 sets the flow distribution factor Qr at 1.0 in a step S16.

When the possible supply flow rate Qa is smaller than the required flow rate Qb, the controller 50 calculates the flow distribution factor Qr using the equation Qr=Qa/Qb in a step S17. In this case, the flow distribution factor Qr takes a smaller value than 1.0.

In a step S18, the controller 50 calculates corrected target operating speeds C7A, C8A, C9A by multiplying the flow distribution factor Qr by the target operating speeds C7 (C7L), C8 (C8L), C9 (C9L) of the respective hydraulic actuators 7, 8, 9. The controller 50 then outputs the calculated corrected target operating speeds C7A, C8A, C9A to the solenoid valves V1-V4 of the respective drive circuits 57-59.

By executing the routine described above, when one of the hydraulic actuators 7-9 is subjected to a large load and substantially stops operating or one of the hydraulic actuators 7-9 reaches the stroke end and substantially stops operating, the target operating speed of the corresponding hydraulic actuator is reset at a smaller value, leading to a reduction in the required flow rate Qb, which is calculated on the basis of the target operating speeds. As a result, a situation in which the required flow rate Qb is calculated to exceed the flow rate actually required by the hydraulic actuators 7-9 can be avoided, and the flow distribution factor Qr can be calculated appropriately at all times. Therefore, when one of the hydraulic actuators 7-9 substantially stops operating, the operating speeds of the other hydraulic actuators are raised quickly. As a result, favorable operating efficiency is maintained in the articulated front attachment 20.

When one of the hydraulic actuators 7-9 substantially stops operating, the target operating speed C7L, C8L or C9L of the hydraulic actuator is set at a very small value larger than 0, and therefore newly usable working oil can be supplied to the operative hydraulic actuators quickly.

In this speed control device, the load pressure of the hydraulic actuator 7-9 is detected by the pressure sensors 18 and 19, and the state in which the hydraulic actuator 7-9 has substantially stopped operating is determined on the basis of the detected load pressure. Hence, there is no need to provide a sensor for detecting the operating speed of the hydraulic actuator 7-9, and as a result, speed control of the hydraulic actuator 7-9 can be realized with a simple constitution.

With regard to the above description, the contents of Tokugan 2007-109417, with a filing date of Apr. 18, 2007 in Japan, are herein incorporated by reference.

Although the invention has been described above with reference to certain embodiments, the invention is not limited to the embodiments described above. Modifications and variations of the embodiments described above will occur to those skilled in the art, within the scope of the claims.

For example, a stroke position of the hydraulic actuator 7-9 may be detected by a stroke sensor, a determination as to whether or not the hydraulic actuator 7-9 has reached a stroke end region may be made on the basis of the stroke position, and when the hydraulic actuator 7-9 has reached the stroke end region, the state in which the hydraulic actuator 7-9 has substantially stopped operating may be considered to be established.

Further, the hydraulic actuator is not limited to a hydraulic cylinder, and may be a hydraulic motor, for example.

In the above embodiment, the parameters required for control are detected using sensors, but this invention can be applied to any device which can perform the claimed control using the claimed parameters regardless of how the parameters are acquired.

### INDUSTRIAL FIELD OF APPLICATION

As described above, with this invention, operating characteristics of a plurality of hydraulic actuators driven using oil pressure from a single oil pressure source can be improved. Accordingly, this invention exhibits particularly favorable effects in improving the operating efficiency of an articulated construction equipment.

The embodiments of this invention in which an exclusive property or privilege is claimed are defined as follows:

1. A speed control device for hydraulic actuators, which controls operating speeds of the hydraulic actuators operated by a working oil discharged from a hydraulic pump, comprising:
control valves that control a supply flow rate of the working oil supplied to the respective hydraulic actuators in accordance with target operating speeds;
a sensor that detects a state in which at least one of the hydraulic actuators has substantially stopped operating; and
a programmable controller programmed to:
set the target operating speeds of the respective hydraulic actuators;
reset the target operating speed of the hydraulic actuator that has substantially stopped operating to a smaller value;
calculate a required flow rate to be supplied by the hydraulic pump on the basis of the reset target operating speed;
calculate a flow distribution factor from a possible supply flow rate of the hydraulic pump and the required flow rate; and
correct the target operating speeds of the respective hydraulic actuators in accordance with the flow distribution factor.

2. The speed control device for hydraulic actuators as defined in claim 1, wherein the smaller value is a very small value larger than zero.

3. The speed control device for hydraulic actuators as defined in claim 1, wherein the sensor is a pressure sensor that detects a state in which a load pressure of the hydraulic actuator exceeds a predetermined pressure.

4. The speed control device for hydraulic actuators as defined in claim 1, wherein the sensor is a stroke sensor that detects a state in which one of the hydraulic actuators has reached a stroke end.

5. The speed control device for hydraulic actuators as defined in claim 1, wherein the hydraulic actuators are constituted by hydraulic actuators that drive an articulated front attachment of a construction equipment.

6. The speed control device for a hydraulic actuator as defined in claim 5, wherein the construction equipment comprises an operating lever, and the controller is further programmed to set the target operating speeds of the respective hydraulic actuators in accordance with an operating speed of the operating lever.

7. The speed control device for a hydraulic actuator as defined in claim 5, wherein the construction equipment comprises an internal combustion engine that drives the hydraulic pump, and the controller is further programmed to calculate the possible supply flow rate of the hydraulic pump from a discharge pressure of the hydraulic pump and a horse power of the internal combustion engine.

8. The speed control device for hydraulic actuators as defined in claim 1, wherein the control valves are constituted by solenoid valves.

9. A speed control method for hydraulic actuators, which controls operating speeds of hydraulic actuators operated by a working oil discharged from a hydraulic pump using control valves that control a supply flow rate of the working oil to the respective hydraulic actuators in accordance with target operating speeds, comprising:
setting the target operating speeds of the respective hydraulic actuators;
detecting a state in which one of the hydraulic actuators has substantially stopped operating;
resetting the target operating speed of the hydraulic actuator that has substantially stopped operating to a smaller value;
calculating a required flow rate to be supplied by the hydraulic pump on the basis of the reset target operating speed;
calculating a flow distribution factor from a possible supply flow rate of the hydraulic pump and the required flow rate and
correcting the target operating speeds of the respective hydraulic actuators in accordance with the flow distribution factor.

10. A speed control device for hydraulic actuators, which controls operating speeds of the hydraulic actuators operated by a working oil discharged from a hydraulic pump, comprising:
control valves that control a supply flow rate of the working oil supplied to the respective hydraulic actuators in accordance with target operating speeds;
means for detecting a state in which at least one of the hydraulic actuators has substantially stopped operating;
means for setting the target operating speeds of the respective hydraulic actuators;
means for resetting the target operating speed of the hydraulic actuator that has substantially stopped operating to a smaller value;
means for calculating a required flow rate to be supplied by the hydraulic pump on the basis of the reset target operating speed;
means for calculating a flow distribution factor from a possible supply flow rate of the hydraulic pump and the required flow rate; and
means for correcting the target operating speeds of the respective hydraulic actuators in accordance with the flow distribution factor.
